(19) United States
(12) Patent Application Publication
(10) Pub. No.: US 2025/0114280 A1
(43) Pub. Date: Apr. 10, 2025

(54) ENTERAL TUBE SYSTEM AND METHODS OF USE

(71) Applicant: Francis Palma Fabrigas, San Antonio, TX (US)

(72) Inventor: Francis Palma Fabrigas, San Antonio, TX (US)

(21) Appl. No.: 18/985,252

(22) Filed: Dec. 18, 2024

Related U.S. Application Data
(63) Continuation-in-part of application No. 18/220,857, filed on Jul. 12, 2023.

(51) Int. Cl. A61J 15/00

(52) U.S. Cl. CPC A61J 15/0092; A61J 15/0003; A61J 15/0015

(57) ABSTRACT

The present invention pertains to the field of medical devices and introduces an enteral tube system designed for efficient and continuous delivery of fluids into a patient's gastrointestinal tract. The system integrates a one-way air valve along the tubular body, allowing ambient air to equalize negative pressure within the tube. This innovative feature enables the plunger of a syringe connected to the syringe port to be removed and the syringe refilled without disconnecting it, ensuring uninterrupted operation. The system also includes an enteral connector with user-controlled fluid flow pathways, enhancing versatility and precision during fluid administration. By addressing challenges such as negative pressure buildup and simplifying the refilling process, the invention reduces handling complexity and improves overall efficiency. The system is suitable for administering enteral fluids, medications, or diagnostic agents in healthcare settings, offering significant advantages over traditional enteral feeding systems.

### CROSS-REFERENCE TO RELATED APPLICATIONS

This application contains subject matter which is related to the subject matter of the following co-pending applications. The below-listed applications are hereby incorporated herein by reference in their entirety:

This is a U.S. non-provisional application is a continuation in part of a U.S. non-provisional patent, Ser. No. 18/220,857, inventor Francis Fabrigas, entitled “ENTERAL CONNECTOR”, filed Jul. 12, 2023, which claims the benefit of U.S. provisional application, Ser. No. 60/389,051, inventor Francis Fabrigas, entitled “ENTERAL CONNECTOR”, filed Jul. 14, 2022, and U.S. provisional application, Ser. No. 63/415,654, inventor Francis Fabrigas, entitled, “ENTERAL TUBE”, filed Oct. 12, 2022.

### TECHNICAL FIELD OF THE INVENTION

The present invention relates to the technical field of medical devices, specifically to systems and methods for enteral feeding. More particularly, the invention is directed to an enteral tube system that enables efficient and continuous delivery of enteral fluids, medications, or diagnostic fluids into a patient's gastrointestinal tract. The system incorporates a one-way air valve integrated along the tubular body, which allows ambient air to enter the tube to equalize negative pressure. This feature enables the plunger of a syringe connected to the system to be removed and the syringe to be refilled without disconnecting it from the syringe port, thereby ensuring uninterrupted operation and reducing handling complexity. The system further includes user-controlled fluid flow pathways via an enteral connector.

### BACKGROUND OF THE INVENTION

Enteral administration of formula, medication, and fluids via an enteral tube is an established practice, commonly utilizing a feeding pump or enteral syringe to deliver nutrition and treatment to patients who cannot eat or take medication orally. Despite the widespread use of current enteral tube systems be it a nasogastric tube, gastric tube, or jejunostomy tube, or 3-way stopcocks and commercially available connectors like ICU Medical's “LOPEZ VALVE” or Dale's “ACE CONNECTOR,” there are significant shortcomings that complicate the administration process and present challenges to healthcare providers.

One major limitation of existing enteral tube systems is the need for frequent manipulation of the tube system as well as the connectors when utilized. These connectors often require repeated opening and closing of ports or the continual disconnection and reconnection of enteral syringes to facilitate fluid delivery, medication administration, or flushing of the tube. For instance, when an enteral syringe is connected to a 3-way stopcock or connector, clinicians must repeatedly manipulate the device to ensure proper flow through the correct pathway. Each step—whether administering formula, delivering medication, or flushing the system—requires either turning the connector dial, opening or closing a port, or physically detaching and reattaching the syringe. This constant handling not only interrupts the workflow but also presents opportunities for user error, especially in high-stress environments where efficiency and accuracy are crucial.

Another key issue arises when refilling the enteral syringe with additional formula, medication, or fluids. To accomplish this, the clinician must often disconnect and reconnect the syringe from the port to remove or retract the plunger, making it difficult to refill the syringe without creating a vacuum inside the system. This suction effect can result in the unwanted aspiration of gastric contents or enteral formula back into the syringe, further complicating the feeding process. This vacuum creation, coupled with frequent disconnection and reconnection, makes what should be a simple process unnecessarily complex and inefficient.

The manual steps required to manage these systems also introduce a range of safety concerns. Each time the syringe port is opened or the connector is adjusted, there is an increased risk of exposure to bodily fluids, such as gastric contents, which can be hazardous to the clinician and pose risks of contamination. Furthermore, the repeated manipulation of the enteral tube system and/or connector during every stage of fluid delivery—whether for feeding, medication, or flushing—leaves ample room for errors. Incorrectly setting the connector dial, failing to properly secure the syringe, or mismanaging the fluid flow can result in leakage and spillage resulting to improper dosing of medication.

The current systems also suffer from workflow inefficiencies. The multiple steps involved in managing these connectors slow down the administration process, especially in situations requiring frequent or complex feeding schedules. Each additional step—disconnecting syringes, rotating connector dials, ensuring proper flow pathways—adds time to the procedure, which could be streamlined with a more efficient system. The cumbersome nature of these steps not only affects the clinician's ability to provide timely care but also increases the mental and physical strain on healthcare providers, who are often working under time-sensitive conditions.

The shortcomings of these systems have persisted for years, creating a long-felt need for an improved solution that addresses these inefficiencies. Clinicians require a system that minimizes handling, reduces the number of manual steps, ensures safety by preventing bodily fluid exposure, eliminates risk of medication waste and streamlines the entire process of enteral fluid administration.

The present invention responds to these challenges by providing a significantly improved/better enteral tube system. By integrating a one-way air valve to the enteral tube and/or the connector or both, the invention eliminates the need for frequent disconnections and reconnections. The invention simplifies the feeding and medication administration process, reduces the risk of contamination and fluid exposure, and increases efficiency by enabling clinicians to manage fluid delivery through a single, intuitive device. Furthermore, the design improves patient safety by minimizing the risks associated with user error, improper dosing, or fluid mismanagement. With these enhancements, the present invention represents a significant advancement in the field of enteral administration, offering a solution that improves both clinician workflow and patient outcomes.

### SUMMARY OF THE INVENTION

The shortcomings of the prior art are overcome and additional advantages are provided through the provision of an enteral tube system that integrates features to address challenges such as negative pressure buildup, backflow prevention, and ease of fluid administration. The system includes a tubular body having a proximal end for fluid communication with an external feeding source and a distal end for insertion into a patient's gastrointestinal tract. A valve port is integrated along the tubular body and configured to receive a one-way air valve, which allows ambient air to enter the tubular body when negative pressure is detected while preventing the backflow of gastrointestinal contents. The system further comprises a removable valve cover operably associated with the valve port, which seals the valve port to prevent operation of the one-way air valve and protect it from external contaminants. Additionally, an enteral connector in fluid communication with the tubular body is configurable to block or unblock fluid pathways, enhancing versatility during operation. These features collectively ensure improved safety, functionality, and convenience during enteral fluid delivery.

Additional shortcomings of the prior art are overcome and additional advantages are provided through the provision of a method of delivering enteral fluids using an enteral tube system that addresses challenges such as negative pressure buildup, efficient fluid delivery, and reduced handling complexity. The method includes inserting a distal end of an enteral tube into a patient's gastrointestinal tract and connecting the proximal end to an enteral feeding system that includes a syringe port in fluid communication with the enteral tube. Fluids are dispensed into the enteral tube using a syringe, and upon removing the syringe plunger, a one-way air valve integrated into the tubular body of the enteral tube is activated to allow ambient air to enter the tube, normalizing negative pressure and preventing vacuum conditions. The syringe can then be refilled without disconnecting it from the syringe port, and the process is repeated until the treatment is complete. This method improves efficiency, minimizes contamination risks, and ensures consistent and reliable fluid delivery.

Additional shortcomings of the prior art are overcome and additional advantages are provided through the provision of an enteral tube system that enhances functionality and fluid delivery versatility. The system comprises a tubular body having a proximal end and a distal end, with the distal end configured for insertion into a patient's gastrointestinal tract. A one-way air valve is integrated into the tubular body to allow ambient air to enter the tubular body when negative pressure is detected, preventing backflow of gastric contents. The proximal end of the tubular body is integrated with an enteral connector, which includes a syringe port for receiving a syringe to dispense fluids and a rotatable valve mechanism for selectively controlling fluid pathways between the syringe port, a feeding bag connection port, and the tubular body. These features collectively provide improved fluid management, reduce handling complexity, and enhance safety and reliability during enteral fluid administration.

Additional features and advantages are realized through the techniques of the present invention. Other embodiments and aspects of the invention are described in detail herein and are considered a part of the claimed invention. For a better understanding of the invention with advantages and features, refer to the description and the drawings.

### BRIEF DESCRIPTION OF THE FIGURES

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of an enteral connector;

FIG. 2 illustrates one example of a disassembled view of an enteral connector;

FIG. 3 illustrates one example of a front view of an enteral connector connected to a feeding pump tubing, an enteral tube, and an enteral syringe with the plunger in a semi-retracted position;

FIG. 4 illustrates one example of a cross-sectional view of an enteral connector;

FIG. 5 illustrates one example of a front view of an enteral connector connected to a feeding bag tubing, an enteral tube, and an enteral syringe with the enteral syringe plunger in a depressed position;

FIG. 6 illustrates one example of a cross-sectional view of an enteral connector;

FIG. 7 illustrates one example of a front view of an enteral connector connected to an enteral feeding bag tube and an enteral tube with the valve port and the enteral syringe port covers in place;

FIG. 8 illustrates one example of a cross-sectional view of an enteral connector;

FIG. 9 illustrates one example of an enteral tube;

FIG. 10 illustrates one example of a close-up elevational view of the proximal end of an enteral tube;

FIG. 11 illustrates one example of a top view of the proximal portion of an enteral tube;

FIG. 12 illustrates one example of a cross-sectional view of the proximal portion of an enteral tube;

FIG. 13 illustrates one example of a top view of an exemplary embodiment of an enteral tube that comprises a removable one-way air valve coupler that couples with the valve port;

FIG. 14 illustrates one example of a cross-sectional view of an exemplary embodiment of an enteral tube that comprises a removable one-way air valve coupler that couples with the valve port;

FIG. 15 illustrates one example of a top view of an exemplary embodiment of an enteral tube with a coupler comprising a one-way air valve connected to the valve port;

FIG. 16 illustrates one example of a cross-sectional view of an exemplary embodiment of an enteral tube with a coupler comprising a one-way air valve connected to the valve port;

FIG. 17 illustrates one example of an exemplary embodiment of an enteral tube connector;

FIG. 18 illustrates one example of a cross-sectional view of an exemplary embodiment of an enteral tube connector;

FIGS. 19-20 illustrate examples of exemplary embodiments of an enteral tube;

FIG. 21 illustrates one example of a coupler that comprises the one-way air valve;

FIG. 22 illustrates one example of a cross-sectional view of a coupler that comprises the one-way air valve;

FIG. 23 illustrates one example of the enteral tube with the proximal part of an enteral tube having a valve port and a syringe/feeding port with a syringe connected to its syringe/feeding port;

FIG. 24 illustrates one example embodiment of an enteral tube having a valve port and two syringe/feeding ports;

FIG. 25 illustrates the example embodiment of the enteral tube with is two syringe/feeding ports connected to a feeding pump tubing and the other to an enteral syringe;

FIG. 26 illustrates one example of a method of using an improved enteral connector;

FIG. 27 illustrates one example of a method of delivering enteral fluids using an enteral tube system; and

FIG. 28 illustrates exemplary embodiments that can be interchangeably used with the methods of the present invention.

The detailed description explains the preferred embodiments of the invention, together with advantages and features, by way of example with reference to the drawings.

### DETAILED DESCRIPTION OF THE INVENTION

The present invention relates to an enteral connector 200 in a 4-way stopcock configuration having four ports and an enteral tube system 100. An advantage, in the present invention, is that the enteral connector 200 has a one-way air valve 205 in one of the ports which allows a syringe to remain connected to the enteral connector 200 while the syringe plunger 232 is removed allowing the syringe 203 to be quickly reloaded with treatment content 504 and avoiding stomach contents from being drawn back into the syringe 230. In contrast, prior enteral connectors require the syringe to be removed from the enteral connector so that the plunger can be retracted or removed and the syringe reloaded. In prior enteral connectors, failure to remove the syringe from the enteral connectors when removing the syringe plunger can result in stomach contents being drawn back into the syringe. For disclosure purposes, stomach contents can be referred to as gastric contents, and such treatment contents 504 can be medications, food, water flush, or other contents as may be required and/or desired in a particular embodiment or patient treatment.

With regard to the enteral tube system 100, the present invention offers significant advantages over prior solutions through the integration of several innovative features that address common challenges in enteral fluid delivery. One of the key features of the present invention is the one-way air valve 124 integrated into the tubular body 102, which is configured to allow ambient air to enter the tube when negative pressure is detected such as during retraction or removal of the plunger from the enteral syringe while connected.

An advantage, in the present invention, is the integration of a one-way air valve mechanism that significantly improves the safety and reliability of the enteral tube system. This valve is designed to automatically open when negative pressure is detected within the tube, particularly during retraction or removal of the plunger as the enteral syringe is connected to the enteral tube, allowing ambient air to enter and equalize the pressure. This feature prevents aspiration of gastric contents and the collapse or blockage of the tube, issues common in prior systems where negative pressure could lead to both aspiration and interruption of fluid flow.

Finally, the present invention includes several features aimed at improving hygiene and reducing contamination risks. The removable valve cover and removable syringe port cover help seal key components when not in use, protecting the system from external contaminants. Additionally, a filtration element 150 integrated into the one-way air valve 124 ensures that only clean air enters the system, further minimizing contamination risks—a feature that provides a clear advantage over prior systems lacking this level of protection.

An advantage, in the present invention, is the inclusion of a filtration element 150 integrated into the one-way air valve. This feature provides an added layer of safety by ensuring that any ambient air entering the tube is filtered, preventing contaminants from entering the system. The filtration element is particularly valuable in clinical settings where exposure to airborne particles, bacteria, or other contaminants can pose significant risks to the patient.

By filtering the air before it enters the enteral tube, the system maintains a sterile environment within the feeding pathway, reducing the likelihood of introducing infections or contaminants into the gastrointestinal tract. This is especially important during prolonged feeding sessions or in patients with weakened immune systems, where the risk of contamination could lead to serious complications. The filtration element 150 works seamlessly with the one-way air valve, ensuring that the pressure-regulating benefits of the valve are achieved without compromising the safety or cleanliness of the system. This enhancement further improves the overall reliability and hygienic standards of the enteral feeding process.

An advantage, in the present invention, is the improvement in user control and safety, which addresses several shortcomings found in prior systems. The invention significantly reduces the need for repeated disconnections and reattachments of the enteral syringe or other components, minimizing the risk of contamination and enhancing workflow efficiency. With the rotatable enteral connector, users can seamlessly manage fluid pathways by selectively opening or closing ports without physically disconnecting any part of the system.

This design reduces the potential for bodily fluid exposure, which is a common concern when handling enteral feeding systems, particularly during medication administration or system flushing. By decreasing the frequency of handling and manipulation, the risk of user error or accidental contamination is also reduced. The system's intuitive design enhances safety for both the clinician and the patient by creating a cleaner and more streamlined feeding process, ultimately minimizing infection risks and improving overall clinical outcomes. The user-friendly controls make the process more efficient and reliable, reducing the mental and physical burden on healthcare providers while maintaining the highest standards of patient care.

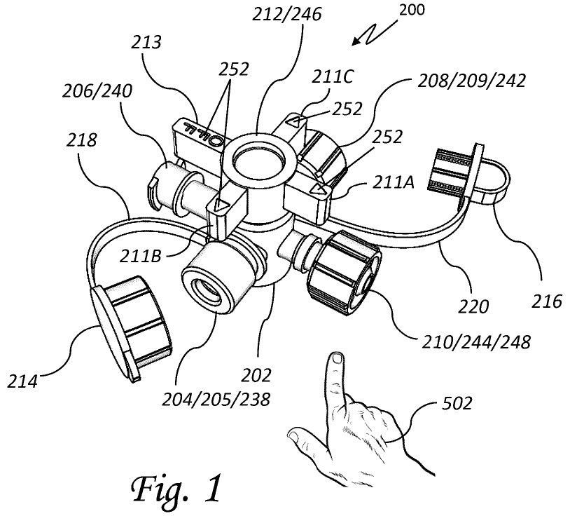

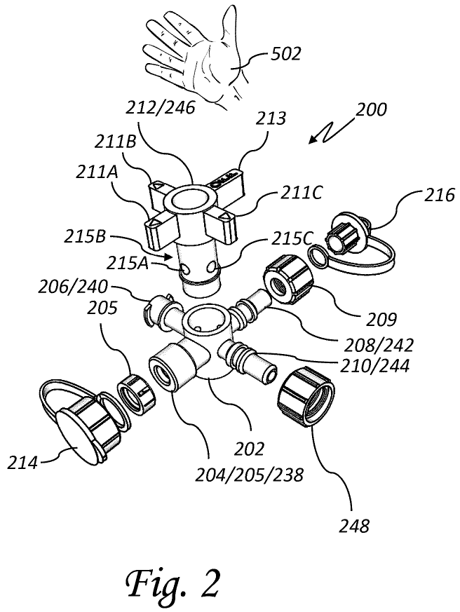

Turning now to the drawings in greater detail, it will be seen that in FIG. 1 there is illustrated one example of an enteral connector 200. In an exemplary embodiment, the enteral connector 200, of the present invention, can comprise a main cylindrical valve body 202 which has a plurality of flow holes 215 that interconnect within the cylindrical valve body 202 which enables a plurality of flow paths 238, 240, 242, 244 that are coupled to the flow holes 215 as better illustrated in at least FIGS. 2 and 4 to pass through the cylindrical valve body 202. A columnar plug 212 is inserted into the cylindrical valve body 202 and is rotatable relative to the cylindrical valve body 202.

The columnar plug 212 is configured with a T-shaped handle 246 that has finger-engageable protrusions 211A, 211B, 211C, and 213. Better illustrated in at least FIG. 2, the T-shaped finger-engageable protrusion 213 corresponds to the side of the cylindrical body 202 for which there is not a flow hole 215 and thus when the columnar plug 212 is rotated by a user 502 whichever port position 204, 206, 208, or 210 the T-shaped finger-engageable protrusion 213 points to has the flow block through the enteral connector 200. In this regard, finger-engageable protrusion 213 can also serve as a flow direction indicator with suitable markings to inform a user 502 of the enteral connector 200.

For disclosure purposes, a user 502 can be a medical person, patient, or other qualified-to-use people, as may be required and/or desired in a particular embodiment.

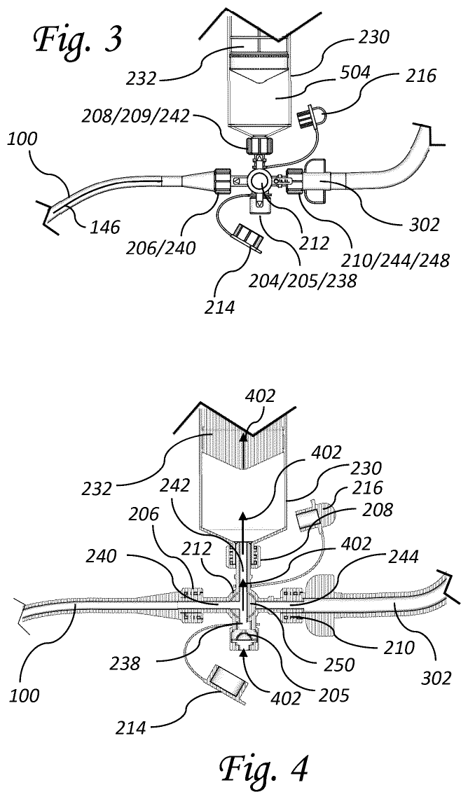

In operation, at least one flow path 238/240/242/244 can be blocked in a first columnar plug position, and when the columnar plug 212 is rotated by way of the T-shape handle to a second columnar position at least one of a different flow path 238/240/242/244 can be blocked. As an example illustrated in FIG. 1, in the first columnar plug 212 position port position 206 flow path 240 is blocked preventing contents from ingressing or egressing through the enteral tube 100. As illustrated in FIG. 2, in a second columnar plug position, port position 208 flow path 242 is blocked preventing contents from ingressing or egressing through the enteral connector from the syringe port 208 and thus from an interconnected syringe 230. As illustrated in FIG. 3, port position 210 flow path 244 is blocked preventing ingress or egress through the feeding bag tube 302.

In a plurality of exemplary embodiment, at least one of the flow paths 238, 240, 242, or 244 can be blocked preventing air or liquid flow through at least one of the flow holes 215A-C. In this regard, the flow state between the flow paths 238, 240, 242, and 244 can be enabled or blocked, as may be required and/or desired by user 502.

In operation, the t-shaped flow hole 215A-C creates a liquid or air connection between ports 204, 206, 208, and 210 and the columnar plug 212 can be rotated to selectively choose the desired port 204, 206, 208, or 210 interconnection pathway. Noting, that port 204 has a one-way air valve and port pathway 238 is an air pathway.

The columnar plug 212 defines a preferred form of central manifold that resides within valve body 202. Air or fluid can flow through each of the fluid pathways 238, 240, 242, or 244 embedded within the columnar plug 212 flow holes 215A-C. In operation, this flow happens when the flow holes 215A-C are aligned with the flow pathways 238, 240, 242, or 244. In this regard, any one of the 4 ports 204, 206, 208, or 210 is opened or closed and the fluid or air entering or exiting the stopcock enteral connector 200 is permitted or blocked so long as the port flow pathway 238, 240, 242, or 244 is open between one of the flow holes 215A-C is open.

In an exemplary embodiment, while the three ports 206, 208, and 210 can allow bi-directional fluid flow, port 204 is provided as a one-way air valve 205 that is configured to allow air to be drawn, from external the enteral connector 200, into the enteral connector 200 and through the flow pathway 244. This allows the syringe plunger 232 to be removed without closing the syringe port 208 and disconnecting the syringe 230. In operation, user 502 can attach syringe 230 to the syringe port 208, turn the columnar plug 212 to close port 210 and then remove and insert the syringe plunger 232 as needed to fill the syringe 230 and dispense the syringe 230 treatment contents 504 into the patient through enteral tube 100 without closing the syringe port 208 and disconnecting the syringe 230 in order to remove the plunger 232 and refill the syringe 230.

In an exemplary embodiment, the columnar plug 212 is provided with indicators 211A-C, and 213 to allow the user 502 to determine which ports are open and which are closed. Such indicator can be embossed or de-embossed in the columnar plug 212 as appropriate so that a user 502 can see the markings.

In an exemplary embodiment, while one port 204 contains a one-way air valve 205, the remaining ports 206, 208, and 210 are configured so that they can connect to other enteral devices such as syringe 230, enteral tube 100, and feeding bag tube 302. Port 204 containing the one-way air valve 205 is provided with a sealing valve port cover 214 to selectively open or close valve port 204 for suctioning gastric contents and to protect and keep the one-way air valve 205 clean.

The cylindrical valve body 202 can comprise a plurality of ports 204, 206, 208, 210, and other ports as may be required and/or desired in a particular embodiment. Also, the cylindrical valve body 202 can comprise a plurality flow path 238, 240, 242, 244, and other flow paths, and flow holes 215A-C, and other flow holes through the columnar plug 212 as may be required and/or desired in a particular embodiment. Various numbers of operating states can be provided to the stopcock by changing the number of ports associated with the valve body and changing the position of the end of the flow path within the columnar plug.

In an exemplary embodiment, the enteral connector 200 of the present invention can comprise an enteral syringe-connectable inlet valve, and a plurality of different kinds, types, or brands of medical grade one-way air valves. The sealing cover 118 can be optionally provided to cover the one-way air valve 205. Additionally, the one-way air valve can be disposed along any part or location on the enteral connector 200. The one-way air valve can be fabricated from a combination of different kinds of materials such as plastic, silicone, metal, rubber, or other materials.

In an exemplary embodiment, the one-way air valve 205 can be integrated with/connected to other enteral devices for enteral use and/or with other applications. Additionally, the one-way air valve 205 can be provided with a filtration element pre, post, or within the one-way air valve 205 system itself. Furthermore, the one-way air valve 205 can be attached or selectively coupled to one of the ports 204, 206, 208, or 210 of valve body 202 as may be required and/or desired in a particular embodiment.

In an exemplary embodiment, ports 204, 206, 208, and 210 can be disposed at different positions, orientations, or locations on the enteral connector 200. Additionally, ports 204, 206, 208, and 210 can be ENFit compatible, legacy compatible, or modified differently to connect with other devices.

Advantages of the enteral connector 200 of the present invention and in contrast with prior devices include a port 204 with one-way air valve 205. The one-way air valve 205 when exposed to negative pressure within the flow pathway 238 caused by the removal motion of the syringe plunger 232, from the syringe 230, allows ambient air to enter the enteral connector 200. In operation, this allows the syringe plunger 232 to be removed without drawing liquid gastric contents from the enteral tube 100 into the syringe 230. Thus the syringe 230 doesn't need to be removed from the enteral connector in order to remove the syringe plunger 232 to refill the syringe 230. As a result, this reduces the number of times the syringe 230 needs to be disconnected and reconnected to the enteral connector 200 thus speeding the administration of enteral formula, medication, or water flush to the patient. The enteral connector 200, of the present invention, also enables a user 502 to be able to select various flow pathways and block other flow pathways by manipulation of the T-shaped handle 246 during administration of formula, medication, or water flush.

Similarly, associated methods of use are unique in that it allows user 502 to be more efficient by having fewer steps to perform during the administration of enteral feeding, medication, and water flushes, promoting clinician (user 502) safety by reducing the risk of body fluid exposure, and helps reduce the risk of errors by providing fewer steps during enteral feeding, medication, and water administration thru the enteral tube 100.

Advantages of the enteral connector 200 of the present invention and in contrast with prior devices include the use of a port 204 with one-way air valve 205, and a valve port cover 214 for valve port 204 with one-way air valve 205 to selectively allow or restrict the use of and airflow through the port 204, the one-way air valve 205, and flow pathway 238. In operation, the one-way air valve 205 is active (allows air to enter the cylindrical body 202 through flow pathway 238 and pass through one of the flow holes 215) when negative pressure is present inside the cylindrical body 202 resulting from the syringe plunger 232 being removed from the barrel of the syringe 230.

Referring to FIG. 1, there is illustrated one example of an enteral connector 200. In an exemplary embodiment, the enteral connector 200 comprises a main cylindrical body 202 with four ports 204, 206, 208, and 210 that are integrally formed along the surface of the main body 202 at intervals in the circumferential direction. The ports 204, 206, 208, and 210 each have a flow pathway 238, 240, 242, and 244 respectively. An outer peripheral surface is supported by the inner peripheral surface of the cylindrical body 202. The enteral connector 200 also comprises a columnar plug 212 that is rotatable relative to the cylindrical body 202. The columnar plug 212 can be formed with a T-shaped handle 211A-C, and 213 and more than one flow hole 215A-C which are better illustrated in at least FIG. 2 so that when the columnar plug 212 is rotated, selectively at least one of the flow pathways 238, 240, 242, and 244 is blocked and the remaining flow paths are coupled together by way of the flow holes 215A-C.

In an exemplary embodiment, the flow holes 215A-C create a fluid/air connection between three of ports 204, 206, 208, and 210, and rotation of the T-shaped handle 211A-C, and 213 selects which of the ports are interconnected and which is port is blocked.

In an exemplary embodiment, the columnar plug 212 is provided with a fluid direction indicator dial 211A-C and 213 that can be manipulated to select which port to open or close. At least three of the four ports 204, 206, 208, and 210 depending on the columnar plug 112 position are in fluid communication by way of flow paths 238, 240, 242, and 242 and flow holes 215A-C inside of the enteral connector 200 wherein fluid communication between ports 204, 206, 208, and 210 are controlled by the columnar plug 212.

In an exemplary embodiment, the first port 204 also called the valve port 204 comprises a one-way air valve 205 to selectively allow external air to be drawn into the enteral connector 200 when negative pressure is present inside the enteral connector 200. At a 90-degree angle from the first port 204 is a second port 206 also called the distal port 206. The second port 206 can be configured as in a female ENFit connector. At a 90-degree angle from the second port 206 can be a third port 208 also called the enteral syringe port 208. The third port 208 can be a male ENFit configuration to receive an ENFit compatible enteral syringe 230. At 90-degrees to the third port 208 can be a fourth port 210 also called the proximal port 210. The fourth port 210 can also be a male ENFit configuration to receive the distal end of a feeding bag tubing 302. The valve port 204 and the enteral syringe port 208 are provided with sealing covers that can be referred to as the valve port cover 214 and the syringe port cover 216 respectively to selectively cover the valve port 204 and enteral syringe port 208 as needed. The fourth port 208 (proximal) can also be provided with a cover as desired and/or required in a particular embodiment. In operation, covering valve port 204 with valve port cover 214 can negate the ability of the one-way air valve 205 to allow air to ingress the enteral connector 200 thus allowing user 502 to configure valve port 204 to enable or disable the operation of one-way air valve 205, as desired or required, by removing the valve port cover 214 from the valve port 204 or sealing closed the valve port 204 with the valve port cover 214 respectively, such as when suctioning gastric contents to check for residuals and for other purposes. Furthermore, the syringe port cover 216 and be used selectively by user 502 to seal and unseal, for hygiene, leak, and other purposes, the enteral syringe port 208.

In an exemplary embodiment, in use, when an enteral feeding pump is used to administer enteral feeding, the proximal port 210 of the enteral connector 200 can be connected to the distal end of the enteral feeding pump tubing 302, and the distal port 206 of the enteral connector 200 can be connected to a patient's enteral tube 100. The t-shaped handle 211A-C and 213 are adjusted or otherwise aligned with the ports 204, 206, 208, and 210 so that the flow holes 215A-C corresponding to the T-shaped handle markings 211A-C of the columnar plug 212 create a fluid communication pathway between the proximal port 210, distal port 206, and valve port 204. The absence of a flow hole along the flow pathway 242 effectively closes the enteral syringe port 208. The valve port cover 214 can be kept in place sealing the valve port 204.

In an exemplary embodiment, when it is time to administer medications through the enteral connector 200, the enteral syringe port cover 216 is removed and an enteral syringe 230 is attached to the enteral syringe port 208. The enteral connector 200 T-shaped handle 211A-C and 213 is turned or otherwise aligned so that the columnar plug 212 flow holes 215A-C create fluid communication between flow pathways 238, 240, and 242 which are associated with the enteral syringe port 208, the valve port 204, and the distal port 206 (enteral tube 100 port). The valve port cover 214 and the syringe port cover 216 can be removed.

In operation, with the enteral syringe 203 in place connected to the syringe port 208, the plunger 232 can be removed from the enteral syringe 230 barrel to prepare for medication administration. In this regard, the mixture of medication can be poured into the barrel of syringe 230 while syringe 230 remains attached to the syringe port 208 and the syringe plunger 232 can be inserted into the syringe 230 barrel and depressed to displace the treatment contents 504 through the enteral connector 200 and into the enteral tube 100. Once syringe 230 is empty, the syringe plunger 232 can be retracted and removed from the barrel of syringe 230. This happens by way of the one-way air valve allowing air to be drawn into the enteral connector 200 to counter the negative pressure the syringe plunger 232 creates as it is being removed. Once removed, syringe 230 can be refilled and the syringe plunger 232 reinserted in syringe 230 to dispense another batch of medication or fluids. This method is repeated until the treatment cycle is completed as necessary. When finished with dispensing medication and water flush, the t-shaped handle 211A-C and 213 can be repositioned or otherwise realigned such that fluid communication is restored between the proximal port 210 and distal port 206. The valve port cover 214 and the syringe port cover 216 can be fastened to seal the valve port 204 and syringe port 28 respectively.

In an exemplary embodiment, to use the enteral connector 200 for gastric emptying by manual aspiration or hooking to intermittent suction, the columnar plug 212 can be positioned so that there is a continuous flow pathway between the distal port 206 (the enteral tube 100 port), the proximal port 210 (connected to suction), and the valve port 204 and enteral syringe port 208 are sealed with their respective valve port cover 214 and syringe port cover 216 to maintain the negative pressure along the flow pathways 240 and 244 inside the enteral connector 200 created by a suction device.

Referring to FIG. 1, there is illustrated one example of an enteral connector 200. In an exemplary embodiment, the enteral connector 200 comprises a main cylindrical body 202, a plurality of ports including valve port 204, distal port 206, syringe port 208, and proximal port 210. Valve port 204 can be integrally formed on the enteral cylindrical body 202 and house a one-way air valve 205. Distal port 206 can be a female ENFit connector and can be integrally formed on the enteral cylindrical body 202. Enteral syringe port 208 and proximal port 210 can be a male ENFit connector and can be integrally formed on the enteral cylindrical body 202. A columnar plug 212 can be inserted inside the cylindrical body 202. A first cover 214 is provided for the valve port 204 and a second cover 216 is provided for the enteral syringe port 208. The covers 214, and 216 can be attached by a flexible strap 218, and 220 to the cylindrical body 202 proximate to their respective port 204/208.

Referring to FIG. 2, there is illustrated one example of a disassembled view of an enteral connector 200. Illustrated, in an exemplary embodiment, is how the cylindrical body 202 can be interconnected with the columnar plug 212, and how the T-shaped handle formed by 211A-C and 213 can be user 502 finger-engageable protrusions that also serve as flow direction indicators with handle protrusion 213 indicating by pointing and with the inscription to the port that is blocked, occluded, or otherwise turned ‘OFF’. The columnar plug 212 has flow holes 215A-C that direct the flow of fluid or air from one port to another through the columnar plug 212 by way of flow pathways 238, 240, 242, and/or 244. The valve port 204 has fastened therein a one-way air valve 205. The enteral syringe port 208 and proximal port 210 have threaded a rotatable collar 209, and 248 surrounding their respective ports 208, and 210 designed to engage to fasten to another compatible-ended enteral device.

In an exemplary embodiment, an improved enteral connector 200 can comprise a cylindrical body 212. The cylindrical body 212 can comprise a valve port 204, a proximal port 210, a distal port 206, and a syringe port 208. The proximal port 210 can be configured to interconnect with a feeding bag tube/suction line 302. The distal port 206 can be configured to interconnect with an enteral tube 100. The syringe port 208 can be configured to interconnect with a syringe 230. The syringe 230 can comprise a syringe plunger 232 that is removable from the barrel of syringe 230.

Continuing, a one-way air valve 205 interconnects with valve port 204 and is configured to allow ambient air to ingress into the cylindrical body 202 through the one-way air valve 205 abating the buildup of negative pressure within the cylindrical valve body 202. And, a columnar plug 212 interconnects with the cylindrical body 202 and can be rotated to at least a proximal port block position (better illustrated in at least FIG. 3). The columnar plug 212 has more than one flow hole 215A-C that is interconnected. Each of the flow holes 215A-C is perpendicular to the outer circumference of the columnar plug 212 and extends inward interconnecting with other of the flow holes 215 proximate to the center of the interior of the columnar plug 212. Each of the flow holes 215 can be positioned on the circumference of the columnar plug 212 in a manner that when the columnar plug 212 is rotated by a user 502, to each block position, fluid communication of air or liquid is allowed to pass through the flow holes 215 between fewer than all of the following: valve port 204, the proximal port 210, the distal port 206, and the syringe port 208.

In an exemplary embodiment and for disclosure purposes, block position refers to the columnar plug 212 being positioned by user 502 to block at least one of the ports 204, 206, 208, or 210. In this regard, the block positions can include the proximal port block position, the distal port block position, the syringe port block position, and the valve port block position.

In the proximal port block position, the proximal port 210 is blocked and the valve port 204, the distal port 206, and the syringe port 208 are interconnected in a fluid communication (air/liquid) manner by flow holes 215A-C. The handle protrusion 213 faces the proximal port 210.

In the distal port block position, the distal port 206 is blocked and the valve port 204, the proximal port 210, and the syringe port 208 are interconnected in a fluid communication (air/liquid) manner by flow holes 215A-C. The handle protrusion 213 faces the distal port 206.

In the syringe port block position, the syringe port 208 is blocked and the valve port 204, the proximal port 210, and the distal port 206 are interconnected in a fluid communication (air/liquid) manner by flow holes 215A-C. The handle protrusion 213 faces the syringe port 208.

In the valve port block position, the valve port 204 is blocked and the syringe port 208, the proximal port 210, and the distal port 206 are interconnected in a fluid communication manner by flow holes 215A-C. The handle protrusion 213 faces valve port 204.

In operation, user 502 rotates the columnar plug 212 to select the proximal port block position (which is better illustrated in at least FIG. 3) where at least one of the flow hole 215 is aligned with each of the syringe port 208, the distal port 206, and the valve port 204 effectuating fluid communication of liquid between the syringe port 208 and the distal port 206, and fluid communication of air between the valve port 204 and the syringe port 208. The proximal port 210 is absent one of the flow holes 215 and blocked from fluid communication. User 502 secures syringe 230 to syringe port 208. During the removal of the syringe, plunger 232 from the syringe 230 air ingresses through the one-way air valve 205 into the cylindrical body 202 abating the buildup of negative pressure that would otherwise draw gastric contents from the enteral tube 100 into the syringe 230, thus allowing the syringe 230 to remain connected to the syringe port 208 while the syringe plunger 232 is removed to refill the syringe 230 with treatment contents 504 during treatment. Such treatment contents 504 can be medications, food, water flush, or other contents as may be required and/or desired in a particular embodiment or patient treatment.

In an exemplary embodiment, a valve port cover 214 can be removable, and when secured seals the valve port 204 closed preventing air from ingressing into the cylindrical body 202 through the one-way air valve 205.

In an exemplary embodiment, in operation, user 502 rotates the columnar plug 212 to select a syringe port block position (better illustrated in at least FIG. 2) where at least one of the flow holes 215 is aligned with the proximal port 210, the distal port 206, and the valve port 204 effectuating fluid communication between the proximal port 210 and the distal port 206. The syringe port 208 is absent one of the flow holes 215 and blocked from fluid communication. In treatment when the suction line 302 is interconnected with the proximal port 210 the user 502 secures the valve port cover 214 to the valve port 204 preventing air from ingressing into the cylindrical body 202 to maintain suction within the cylindrical body 202 during treatment.

In an exemplary embodiment, in operation, user 502 rotates the columnar plug 212 to select a distal port block position (which is better illustrated in at least FIG. 1) where at least one of the flow holes 215 are aligned with each of the syringe port 208, the proximal port 210, and the valve port 204 effectuating fluid communication of liquid between the syringe port 208 and the proximal port 210, and fluid communication of air between the valve port 204 and the syringe port 208. The distal port 206 is absent one of the flow holes 215 and blocked from fluid communication. User 502 secures syringe 230 to syringe port 208. During the removal of the syringe plunger 232 from the syringe 230 air ingresses through the one-way air valve 205 into the cylindrical body 202 abating the buildup of negative pressure that would otherwise draw gastric contents into the syringe 230, thus allowing the syringe 230 to remain connected to the syringe port 208 while the syringe plunger 232 is removed to refill the syringe 230 with treatment contents 504 during treatment.

In an exemplary embodiment, each of the valve port 204, proximal port 210, syringe port 208, and distal port 206 can be positioned at 90-degree increments around the circumference of the cylindrical body 212.

In an exemplary embodiment, each of the proximal port 210, distal port 206, and syringe port 208 are ENFIT compatible.

In an exemplary embodiment, a T-shaped handle 246 can comprise a plurality of protrusions 211A-C and 213, when the columnar plug 212 is rotated to the proximal port block position (illustrated in at least FIG. 3) the plurality of protrusions are aligned with the valve port 204, proximal port 210, distal port 206, and the syringe port 208. The plurality of protrusions 211A-C and 213 comprise indicia that in the proximal port block position indicate the proximal port 210 is off or blocked (protrusion 213) and the distal port 206, the syringe port 208, and the valve port 204 are open or unblocked (protrusions 211A-C).

In an exemplary embodiment, the T-shaped handle 246 can be integrally formed on the columnar plug 212.

In an exemplary embodiment, a syringe port cover 216 can be removable, and when secured seals the syringe port 208 closed.

Referring to FIG. 3, there is illustrated one example of a front view of an enteral connector 200 connected to a feeding pump tubing 302, an enteral tube 100, and an enteral syringe 230 with the plunger 232 in a semi-retracted position. In an exemplary embodiment, the proximal port 210 is connected to a feeding bag tubing 302 and the distal port 206 is connected to a patient's feeding bag tube 100 with both covers 214, and 216 unfastened to their respective ports 204, and 208. Additionally, an enteral syringe 230 is connected to the enteral syringe port 208. The valve port 204, distal port 206, and enteral syringe port 208 are open while the proximal port 210 is closed as indicated by the columnar plug ‘OFF’ protrusion indicator 213 that is directed towards the proximal port 210.

In an exemplary embodiment, an improved enteral connector 200 can comprise a cylindrical body 202, a valve port 204 interconnected on the circumference of the cylindrical body 212, and a one-way air valve 205 that interconnects with the valve port 204 and is configured to allow ambient air to ingress into the cylindrical body 202 through the one-way air valve 205 abating buildup of negative pressure within the cylindrical valve body 202.

Continuing, the improved enteral connector 200 can comprise a valve port cover 214 that can be removed, and when secured seals the valve port 204 closed preventing air from ingressing into the cylindrical body 202 through the one-way air valve 205. A proximal port 210 is interconnected on the circumference of the cylindrical body 212. The proximal port 210 can be configured to interconnect with a feeding bag tube/suction line 302. A distal port 206 can be interconnected on the circumference of the cylindrical body 212. The distal port 206 can be configured to interconnect with an enteral tube 100. A syringe port 208 can be interconnected on the circumference of the cylindrical body 212. The syringe port 208 can be configured to interconnect with a syringe 230. The syringe 230 can comprise a syringe plunger 232 that is removable from the barrel of syringe 230.

Continuing, the improved enteral connector 200 can comprise a columnar plug 212 that interconnects with the cylindrical body 202 and is rotatable to at least a proximal port block position (better illustrated in at least FIG. 3). The columnar plug 212 has more than one flow hole 215A-C that is interconnected. Each of the flow holes 215A-C is perpendicular to the outer circumference of the columnar plug 212 and extends inward interconnecting with other of the flow holes 215 proximate to the center of the interior of the columnar plug 212. Each of the flow holes 215 can be positioned on the circumference of the columnar plug 212 in a manner that when the columnar plug 212 is rotated by a user 502, to each block position, fluid communication of air or liquid is allowed to pass through the flow holes 215 between fewer than all of the following: valve port 204, the proximal port 210, the distal port 206, and the syringe port 208. In operation, user 502 rotates the columnar plug 212 to select the proximal port block position where at least one of the flow holes 215A-C can be aligned with each of the syringe port 208, the distal port 206, and the valve port 204 effectuating fluid communication of liquid between the syringe port 208 and the distal port 206, and fluid communication of air between the valve port 204 and the syringe port 208. The proximal port 210 is absent one of the flow holes 215 and blocked from fluid communication. User 502 secures syringe 230 to syringe port 208. During the removal of the syringe, plunger 232 from the syringe 230 air ingresses through the one-way air valve 205 into the cylindrical body 202 abating the buildup of negative pressure that would otherwise draw gastric contents from the enteral tube 100 into the syringe 230, thus allowing the syringe 230 to remain connected to the syringe port 208 while the syringe plunger 232 is removed to refill the syringe 230 with treatment contents 504 during treatment.

Referring to FIG. 4, there is illustrated one example of a cross-sectional view of an enteral connector 200 showing the columnar plug 212 positioned with protrusions 211A-C indicating the flow pathways 238, 240, and 242 of the ports 204, 206, and 208 are open and the absence of a flow hole, stop 250 blocks the flow pathway 244 effectively blocking ‘OFF’ the proximal port 210. An enteral syringe 230 assembly is connected to the enteral syringe port 208 wherein the enteral syringe plunger 232 can be inserted and retracted from the barrel of the syringe 230. In operation, indicated by arrow 402, with a higher resistance from the distal enteral tube port 206 fluid pathway 240 and the valve port cover 214 removed, as the syringe plunger 232 is removed from the syringe 230 negative pressure is generated within the enteral connector 200. In this regard, the one-way air valve 205 opens up allowing air (as shown by arrow 402) to enter and pass through the enteral connector 200 and into the enteral syringe 230 to eliminate the negative pressure the motion of removing the syringe plunger 232 created thereby allowing the enteral syringe plunger 232 to be easily removed out of the barrel of the enteral syringe 230 without having to disconnect the syringe 230 from the enteral connector 200.

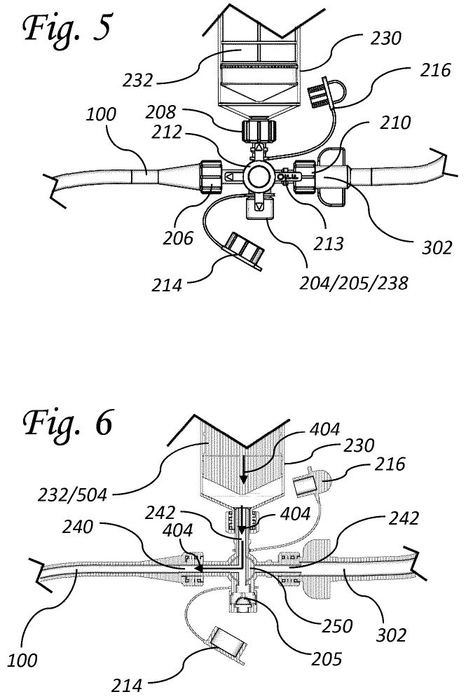

Referring to FIG. 5, there is illustrated one example of a front view of an enteral connector 200 connected to a feeding bag tubing 302, an enteral tube 100, and an enteral syringe 230 with the enteral syringe plunger 232 in a depressed position. In an exemplary embodiment, the enteral connector 200 the proximal port 210 can be coupled to a feeding bag tubing 302 (feeding bag not shown) and the distal port 206 can be coupled to a feeding bag tube 100 respectively with the proximal port 210 closed as indicated by the columnar plug 212 ‘OFF’ protrusion 213 position. An enteral syringe 230 can be connected to the enteral syringe port 208.

Referring to FIG. 6, there is illustrated one example of a cross-sectional view of an enteral connector 200 (with the T-shaped handle 211A-C and 213 and columnar plug 212 positioned as in FIG. 5). In an exemplary embodiment, in this configuration, when the syringe plunger 232 is being pushed 404 towards the end of the barrel as indicated by the arrows, the treatment contents 504 of the enteral syringe 230 are displaced and expelled towards the enteral connector 200 syringe port 208 flow pathway 242 then to the distal port 206 flow pathway 240 by way of the flow holes 215 and into the enteral tube 100 as the one-way air valve 205 remains closed (even when the valve cover 214 is open) in a neutral position during this time preventing leakage of contents. The absence of a flow hole 215 effectively stops 250 the flow of the contents through the proximal port 210 and into the feeding bag tube 302.

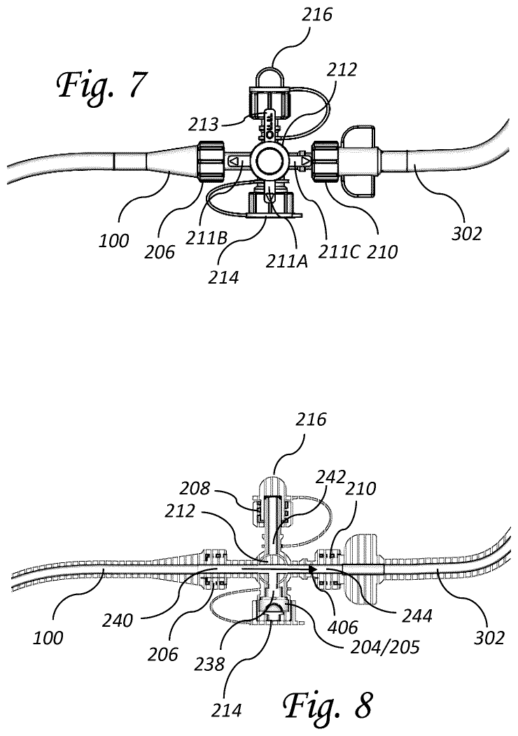

Referring to FIG. 7, there is illustrated one example of a front view of an enteral connector 200 connected to an enteral feeding bag tube 302 and an enteral tube 100 with the valve port cover 214 and the enteral syringe port cover 216 secured in place. Additionally, the columnar plug 212 is illustrated with the T-shaped handle ‘OFF’ protrusion 213 block or otherwise closing the enteral syringe port 208 with the t-shaped handle protrusions 211A-C illustrated that the proximal port 210, distal port 206 and valve port 204 are in the open position.

Referring to FIG. 8, there is illustrated one example of a cross-sectional view of an enteral connector 200 (with the T-shaped handle 211A-C and 213 and columnar plug 212 positioned as in FIG. 7). In an exemplary embodiment, when negative pressure such as during suctioning is generated on the feeding bag tube 302 port 210 and the columnar plug 212 positions in a manner to create a flow pathway 240/244 path between the distal port 206 and the proximal port 210, and the valve port cover 214 and the enteral syringe port cover 216 are secured in place to maintain the negative pressure during suctioning the fluid direction is indicated by the arrow 406 from the distal port 206 towards the proximal port 210.

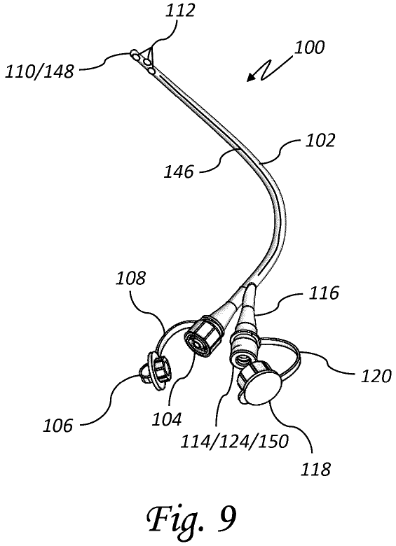

Referring to FIGS. 9-22, there is illustrated one example of an enteral tube 100. When contrasted to prior enteral tubes the enteral tube 100 of the present invention includes the use of a valve port 114 with an incorporated one-way air valve 124. In operation, the advantage is that the ambient air can enter the enteral tube 100 through the one-way air valve 124 to abate the buildup of negative pressure that can interfere with the flow operation within the enteral tube 100 when objects or apparatus such as enteral syringes are used. The one-way air valve allows such devices and apparatus to be used without further manipulation of the tubing system. With regards to enteral syringe use this use of the one-way air valve 124 to abate negative pressure such as when a syringe plunger is removed from the enteral syringe minimizes the number of disconnection-reconnection of the enteral syringe from a feeding port 104 of the enteral tube 100 during enteral feeding administration.

Similarly, the benefits of the use of the enteral tube 100 include 1) allows user 502 to be more efficient by allowing less manipulation of the enteral tubing 100 system during the administration of enteral feeding, medication, and water flushes; 2) promotes clinician safety by reducing the risk of body fluid exposure; and 3) helps reduce the risk of errors by providing fewer steps during enteral feeding, medication, and water administration thru the enteral tube. 4) eliminating repeated disconnection and reconnection helps eliminate spillage and medication waste and underdosing.

The enteral tube is structurally different from prior enteral tubes. More specifically, the enteral tube 100 of the present invention includes 1) a means that allows one-way entry of air into the inner diameter of an enteral tubing 100; 2) a cover 118 for the valve port 114 with one-way air valve 124 to selectively allow or restrict air to enter through the valve port 114 with one-way air valve 124; 3) a one-way air valve 124 that is activated (allows air to enter) when negative pressure is applied from the inside of enteral tube 100; and 4) has a plurality of fluid pathways one of which is a valve port 114 with one-way air valve 124.

In an exemplary embodiment, an enteral tube 100 can have a one-way air valve 124 positioned in valve port 114. In this regard, the enteral tube 100 can comprise a flexible elongated tubular body 102 with proximal and distal 110 ends. At the proximal end, there can be a proximal port 104 and a valve port 114. The valve-port 114 can comprise a one-way air valve 124. The proximal port 104 can be interconnected with the enteral connector 200 or in applications that don't use the enteral connector 200 the proximal port 104 can be connected to an enteral syringe, feeding bag tube 302 or other compatible ENFit device. For disclosure purposes, the proximal port 104 can also be referred to as the feeding port 104.

In an exemplary embodiment, the enteral tube 100 can be fabricated from flexible or rigid materials such as plastic, silicone, metal, rubber, other materials, or a combination of such materials as may be required and/or desired in a particular embodiment. Provided on the distal end 110 of the tubular body 102 are a plurality of holes 112 that are in fluid (air/liquid) communication with the valve port 114 and the proximal port 104. The valve port 114 comprises a one-way air valve 124 that allows ambient air to enter the tubular duct 116 and is disposed to the tubular body 102 preferably in a Y-shaped configuration.

The valve port 114 can also comprise a valve cover 118 that can be opened and sealed closed over the one-way air valve 124 as needed such as during aspiration of gastric contents and when the enteral tube 100 is connected to suction for gastric decompression and/or gastric emptying or to an enteral stringe for gastric residual checks.

Advantages, in the present invention, of the enteral tube 100 include an enteral syringe-connectable valve body and interoperability with a plurality of different types and manufacturers of one-way air valves. Additionally, valve port 114 can be disposed at different positions or locations along the enteral tube 100, and valve port 114 can include a valve cover 118. Furthermore, the valve port 114 can be integrated with or coupleable to other types of enteral devices for enteral use and/or with other applications.

In an exemplary embodiment, the enteral tube 100 can be any kind of enteral tube such as a Nasogastric Tube (NGT), Percutaneous Endoscopic Gastrostomy (PEG) tube, Jejunostomy tube (JT), or other types and/or kinds of enteral tubes as may be required and/or desired in a particular embodiment.

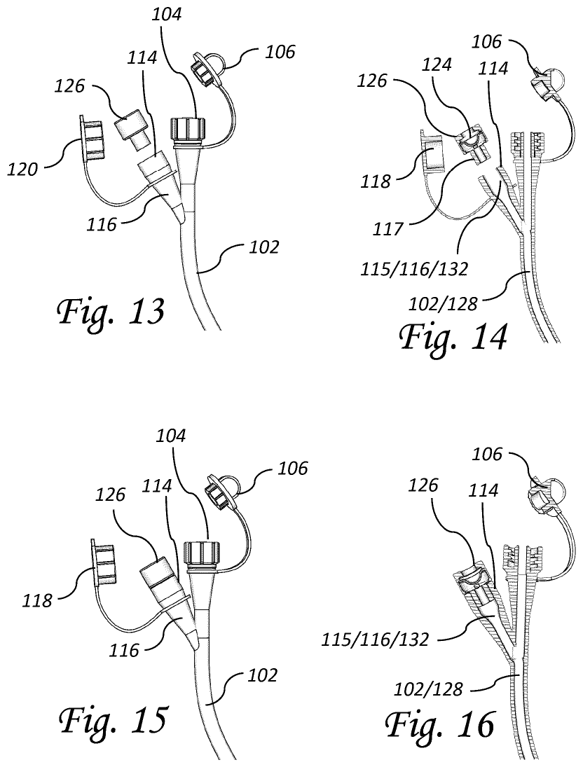

Other advantages, in the present invention, are that the proximal port 104 can be ENFit compatible, legacy compatible, or modified differently to connect with other devices, and has a valve port 114 that can be provided with a filtration element pre, post, or within the one-way air valve 124 itself. As illustrated in at least FIG. 13, valve port 114 can be configured to selectively couple to one end of a valve port coupler 126 and on the other end to other enteral devices. In this regard, in an exemplary embodiment, the one-way air valve 124 can be integrated into the valve port coupler 126, and selectively, the valve port coupler 126 can be configured to interconnect with other enteral devices.

Referring to FIG. 9, there is illustrated one example of an enteral tube 100. In an exemplary embodiment, a tubular body 102 has proximal and distal end 110. At the proximal end is a proximal port 104 which can be configured as an ENFIT compatible male connector and the distal end 110 comprises a plurality of openings 112. Adjacent to the proximal port 104 is a branch from the tubular body 102 forming a valve port 114. The valve port 114 comprises a one-way air valve 124. The proximal port 104, which can be interconnected with a feeding bag tube connected from a feeding bag tube, comprises a removable proximal port cover 106 that can be attached to the neck of the proximal port 104 by a strip of flexible material 108. In a similar manner, valve port 114 can comprise a removable valve cover 118 that is attached to the valve port neck 116 by a strip of flexible material 120. The distal end 110 of the enteral tubing has a plurality of holes 112 serving as outlets to allow content to traverse between the holes 112 and the proximal port 104 and valve port 114. In this regard, the proximal port 104, and valve port 114 are in fluid (air/liquid) communication with the plurality of holes 112 that are located proximate to the distal end 110.

In an exemplary embodiment, an enteral tube system 100/200 efficiently delivers enteral fluids to a patient's gastrointestinal tract. The enteral tube system 100/200 is particularly designed to manage pressure imbalances, improve fluid flow control, and enhance patient comfort. The enteral tube system 100/200 includes a tubular body 102 with a proximal end for connection to an external feeding source and a distal end that delivers enteral fluids into the patient. The proximal end of the tubular body is adapted for fluid communication with a feeding system, such as a pump or gravity-based delivery setup, ensuring compatibility with standard feeding devices.

The distal end of the tubular body is inserted into the patient's gastrointestinal tract and is equipped with a plurality of openings 112 that allow for the delivery of fluids into the patient. This design supports effective nutrient transfer or medication delivery into the digestive system, minimizing the risk of fluid buildup or backflow. The tubular body 102 is constructed from biocompatible materials, including silicone, polyurethane, or latex, to provide flexibility, durability, and comfort during extended use.

In an exemplary embodiment, the enteral tube system includes a one-way air valve integrated into the tubular body, configured to allow ambient air to enter the tube when negative pressure is detected especially during retraction and/or removal of the plunger as the enteral syringe is connected to the enteral tube. The valve is designed to maintain the internal pressure of the tube, preventing collapse during the removal of the plunger of the connected enteral syringe. The one-way air valve activates when the negative pressure within the tube reaches a threshold within a range of −10 mmHg to −30 mmHg, more preferably a range of −15 mmHg to −25 mmHg, and optimally at an approximate threshold of −20 mmHg.

The −20 mmHg threshold has been determined through clinical testing and evaluation as the most effective point for balancing internal and external pressures during enteral feeding. This pressure threshold is optimal because it corresponds to the natural range of negative pressures that can occur within the gastrointestinal tract during normal feeding conditions.

Another component of the system is the rotatable enteral connector 200 which is in fluid communication with the tubular body 102. The enteral connector 200 allows the user to control fluid flow by selectively blocking or unblocking pathways within tube 102 through simple rotation. This feature enables precise control over the delivery of fluids and use of a syringe connection, allowing the user to adjust the feeding and medication process according to the patient's needs or medical requirements. The enteral connector 200 is further enhanced by visual markings 252 that indicate the position of the fluid pathways, offering the user a clear and intuitive method of determining the connector's position during feeding or when adjusting the system.

The enteral tube system also includes a flexible portion of the tubular body 102, positioned near the proximal end. This flexible section ensures that the tube maintains fluid flow even as the patient moves or adjusts their position, preventing kinks or interruptions in the fluid delivery. This feature provides added comfort for the patient, allowing them to move more freely without impacting the feeding process. Additionally, the tubular body 102 can be marked with a radiopaque stripe 146 along its length to assist in tracking the position of tube 102 during insertion or repositioning. The stripe 146 is visible under X-ray imaging, enabling healthcare providers to verify that the tube is properly placed within the gastrointestinal tract, which is critical for avoiding complications during feeding.

An optional feature of the system is the inclusion of a weight 148 attached to the distal end of the tubular body 102. This weight 148 aids in guiding the tube into the desired location within the gastrointestinal tract, helping to maintain the tube's position and preventing accidental dislodgment during use. This ensures that the enteral fluids are delivered to the correct location within the patient's body, optimizing the effectiveness of the feeding process.

In operation, the enteral tube system 100/200 is connected to an external feeding source via the proximal end, and fluids are delivered through the tube into the patient. If negative pressure builds within tube 102, the one-way air valve allows ambient air to enter, preventing the collapse of the tube and maintaining consistent fluid delivery. After the feeding is complete, user 502 can reseal valve port 114 with the removable valve cover 118, ensuring the system remains clean and ready for the next use. The radiopaque stripe 146 ensures proper placement of the tube (by way of X-ray) 102 throughout the procedure, reducing the risk of misplacement or complications.

Overall, the enteral tube system 100/200, of the present invention, provides an innovative solution for enteral feeding by integrating pressure management, user control, and enhanced patient comfort. The system's flexible design and ease of use make it ideal for both short-term and long-term enteral feeding applications, providing reliable, safe, and effective fluid delivery to patients.

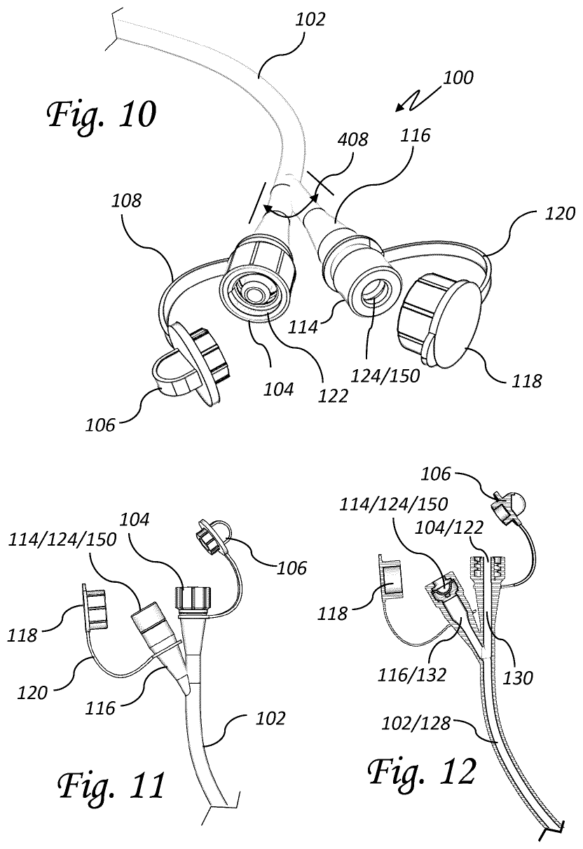

Referring to FIG. 10, there is illustrated one example of a close-up elevational view of the proximal end of an enteral tube 100. In an exemplary embodiment, the enteral tube 100 proximal port 104 has threads 122 on the inner surface that are connectable to ENFit compatible devices.

In an exemplary embodiment, the valve port integrated into the tubular body is positioned at an angle 408 relative to the longitudinal axis of the enteral tube. This angled 408 configuration is designed to optimize airflow dynamics and pressure regulation, especially during patient movement. The valve port is angled 408 within a range of 15 to 45 degrees relative to the longitudinal axis of the tubular body, more preferably within a range of 20 to 35 degrees, and optimally within an angle range of approximately 25 to 30 degrees.

This range provides the most effective response to pressure fluctuations in the tube, ensuring that the one-way air valve can introduce ambient air during negative pressure events. The optimal range of 25 to 30 degrees strikes the best balance, allowing air to flow into the tube while preventing the backflow of gastrointestinal contents. This design maintains tube patency and ensures continuous fluid delivery without the risk of collapse during dynamic patient movements, such as shifting positions or changes in posture.

The angled valve port improves the system's ability to prevent blockages by minimizing the risk of being obstructed by bodily fluids or gastrointestinal tissues. This is particularly critical during feeding or medication administration, where a straight or vertically aligned port might become blocked. The optimal angle of 25 to 30 degrees provides the most efficient pathway for ambient air to enter the system without interference from internal obstructions or external forces.

Additionally, the angled design allows for easier access during maintenance and cleaning. Clinicians can more easily reach the valve port, remove or reseal the valve cover, and ensure that the system is functioning properly. This access also ensures that the valve remains free from buildup or contamination, which can occur if the port is positioned at an inefficient angle.

By angling the valve port within the preferred range of 20 to 35 degrees, the system ensures that pressure relief is provided promptly when needed, while minimizing any disruptions to the feeding process. The optimal angle range of 25 to 30 degrees has been shown to offer the best compromise between accessibility, functionality, and maintaining consistent air entry, making the system highly adaptable to patient conditions.

This angled valve port design offers several key benefits, including:
Enhanced pressure regulation, with the valve activating efficiently to normalize pressure at the optimal angle.
Improved airflow dynamics, ensuring that air enters the tube without blockage from fluids or internal anatomy.
Reduced risk of backflow, as the angled port promotes proper fluid movement within the tube.

Simplified maintenance and cleaning, with easy access to the valve port at the optimal angle for ergonomic use by clinicians.
Greater reliability in maintaining fluid flow during patient movement, ensuring continuous and safe enteral feeding or medication administration.

The inclusion of these angle 408 ranges in the design ensures that the one-way air valve operates at peak performance, providing both clinical and functional benefits that surpass prior systems.

Referring to FIGS. 11 and 12, there is illustrated one example of a top view of the proximal portion of an enteral tube 100. FIG. 12 is a cross-sectional view of the proximal portion of an enteral tube 100 which is illustrated in FIG. 11. In an exemplary embodiment, the one-way air valve 124 and how the flow pathway ducts 128, 130, and 132 are in fluid communication with each other.

Referring to FIGS. 13 and 14, there is illustrated one example of a top view of an exemplary embodiment of an enteral tube 100 with a one-way air valve coupler 126 that couples with the valve port. FIG. 14 is a cross-sectional view of FIG. 13. In an exemplary embodiment, one-way air valve coupler 126 can be removably coupled, and detached from the valve port 114. FIG. 13 illustrates how the distal and connecting end 117 of valve port 114 can be configured to receive the one-way air valve coupler 126 within the inner diameter 115 of the valve port 114 opening. The valve port 114 opening can be ENFIT compatible and the distal end 117 of the one-way air valve coupler 126 can be an ENFIT tip. In an exemplary embodiment, the one-way air valve coupler 126 can be configured to have a female ENFIT connector tip and the valve port 114 can be configured to be a male ENFIT port.

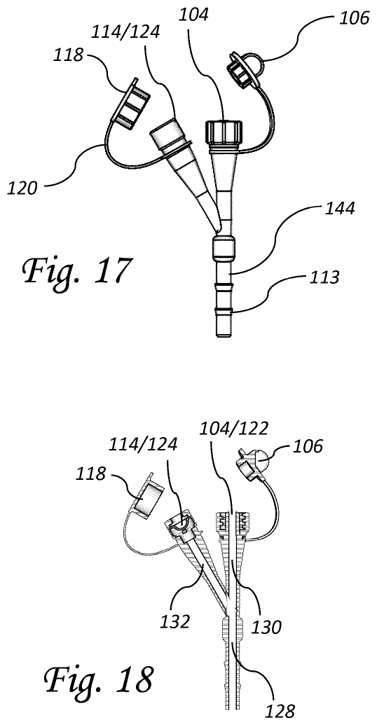

Referring to FIGS. 15 and 16, there is illustrated one example of an exemplary embodiment of an enteral tube 100 with a coupler 126 comprising a one-way air valve 124 connected to valve port 114. In this regard, FIG. 15 is the same embodiment of FIG. 13 with the valve-containing port 126 connected to valve port 114 and shown in FIG. 16 in its cross-sectional view.

Referring to FIGS. 17 and 18, there is illustrated one example of an exemplary embodiment of an enteral tube 100 connector. FIG. 18 is a cross-sectional view of FIG. 17. In an exemplary embodiment, the enteral tube 100 can comprise a short primary tubing 144 of rigid material and ring bumps 113 to increase friction against the inner diameter of a coupled device and with the proximal port 104 and the valve port 114. FIG. 18 illustrates how the flow pathway ducts 130, 128, and 132 are in fluid (air/liquid) communication with each other.

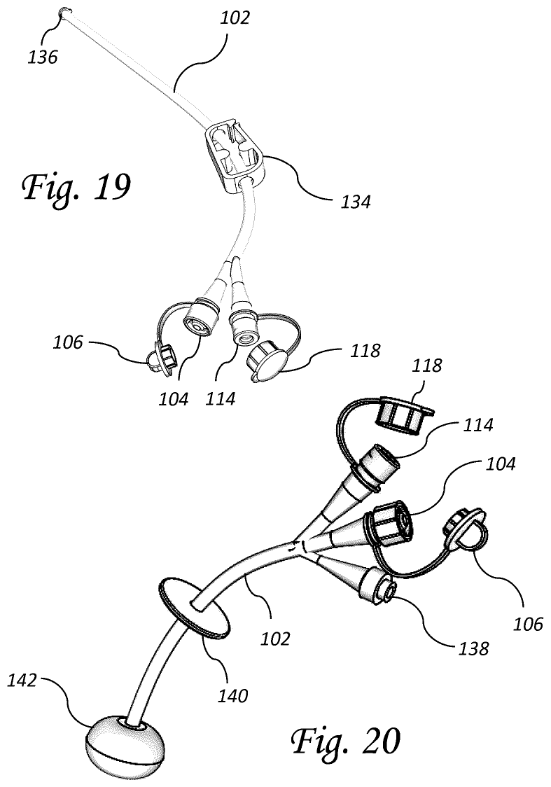

Referring to FIGS. 19 and 20, there are illustrated exemplary embodiments of the enteral tube 100. In an exemplary embodiment in FIG. 19, there is illustrated one example of the enteral tube 100 comprising a flexible main tubing 102 as well as having a connectable locking tip 136 for connection to low-profile enteral tubes such as MIC tube and a clamp 134 for flow control and with the same proximal openings of proximal port 104 and valve port 114.

In an exemplary embodiment in FIG. 20, there is illustrated one example of an enteral tube 100 comprising a flexible main tube 102, a disc stabilizer 140, and having an anchoring-element inflatable balloon 142 disposed at the distal end. The system includes three proximal ports: the one-way valve port 114, the proximal port 104, and the balloon-inflation port 138.

The inflatable balloon 142 is designed to serve as an anchoring element, securing the distal end of the enteral tube within the patient's gastrointestinal tract, typically in the stomach or small intestine. Upon insertion of the tube, the balloon is inflated to gently press against the internal walls of the organ, holding the tube in place and preventing it from shifting or migrating during feeding or medication administration. This secure positioning ensures consistent delivery of fluids to the correct location and reduces the risk of complications associated with tube displacement, such as aspiration or improper nutrition delivery.

The balloon-inflation port 138 provides a dedicated pathway for inflating and deflating the balloon 142. The inflation port is in fluid communication with the balloon and allows the clinician to introduce air or another suitable inflation medium, such as saline, to expand the balloon. This port is typically accessed using a syringe or other inflation device. Once the balloon is adequately inflated, the inflation port 138 includes a mechanism, such as a one-way valve, that prevents the backflow of air or fluid, ensuring the balloon remains securely inflated until intentional deflation is required.

The inclusion of the inflatable balloon 142 and the balloon-inflation port 138 enhances the stability of the enteral tube and provides the clinician with precise control over the anchoring process, allowing for secure placement without the need for invasive surgical procedures or external fixation devices. This configuration helps to prevent tube dislodgment, especially in active or mobile patients, while also minimizing discomfort during long-term use.

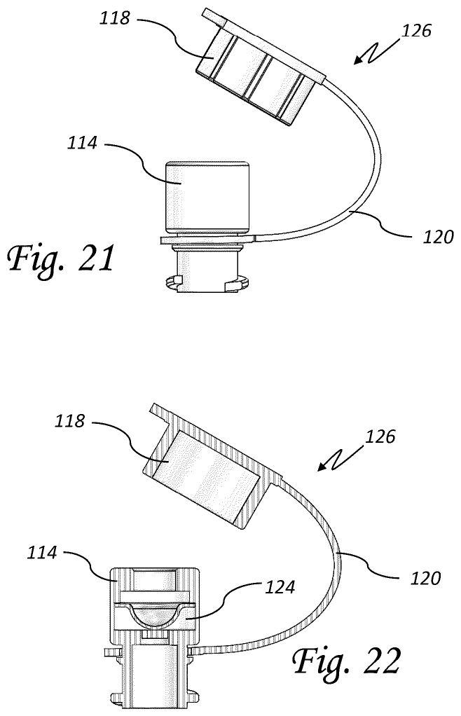

Referring to FIGS. 21 and 22, there is illustrated one example of a one-way valve coupler 126. FIG. 22 is a cross-sectional view of FIG. 21. In an exemplary embodiment, the one way valve coupler 126 (also illustrated in at least FIGS. 14 and 15) can have an ENFit connectable tip 150 for interconnection with other ENFit enteral devices.

In an exemplary embodiment, the enteral tube system 100/200 is designed for enhanced versatility, providing solutions for both enteral feeding and the administration of medications or fluids. The system includes a tubular body 102 with a proximal end configured for connection to external feeding or medication delivery devices, and a distal end for fluid delivery into a patient's gastrointestinal tract. The tubular body 102 can be equipped with a valve port 114 that integrates a one-way air valve 124, which allows ambient air to enter the system when negative pressure is detected, thus preventing the collapse of the tube while ensuring that gastrointestinal contents do not escape or get aspirated by a connected enteral syringe during plunger removal.

A rotatable enteral connector 200 can be positioned within the system in fluid communication with the tubular body 102. This connector 200 allows for selective control over fluid pathways, enabling users 502 to direct fluid flow as needed for feeding, medication administration, or other procedures such as flushing. The rotatable feature offers greater flexibility, allowing users 502 to adjust the system to meet various patient care needs without requiring complex adjustments or disconnections.

To accommodate patient movement, the system includes a flexible section of the tubular body 102 located near the proximal end. This flexible section prevents kinking or occlusion of the tube, ensuring uninterrupted fluid flow even as the patient shifts or changes position. This feature enhances patient comfort and is especially valuable during long-term feeding, where consistent fluid delivery is crucial.

Additionally, the system incorporates a syringe port 208 that is in fluid communication with the tubular body 102. This syringe port 208 facilitates the introduction of medications, flush cleaning solutions, or diagnostic fluids while maintaining fluid flow for enteral feeding. The syringe port 208 includes a dedicated connector near the proximal end of tube 102, allowing for secure and easy attachment of a syringe. This dedicated connector ensures that fluids or medications can be introduced without interfering with the primary feeding pathway.

A removable syringe port cover 216 is operably associated with the syringe port 208. This cover is designed to seal the port when it is not in use, protecting the system from contaminants and maintaining hygiene between uses. The cover can be easily removed and reattached, allowing for quick cleaning and ensuring that the syringe port remains sterile for future procedures.

To further safeguard against contamination, the one-way air valve 124 may include a filtration element 150 that ensures only clean air enters the system during pressure equalization. This filtration mechanism 150 helps maintain a clean internal environment, which is especially important in medical settings where preventing contamination is critical to patient safety.

The enteral connector is marked with visual indicia that indicate the open or closed status of the fluid pathways. These markings 252 provide clear feedback to the user, reducing the risk of errors during operation. The visual indications 252 allow healthcare providers to easily confirm the system's current configuration, whether they are feeding, administering medication, or flushing the tube 102.

The tubular body is made from durable, biocompatible materials such as polyvinyl chloride (PVC) or thermoplastic elastomer (TPE). These materials provide a balance of strength and flexibility, making the system suitable for extended use while remaining comfortable for the patient. The materials are also resistant to degradation in the presence of bodily fluids, ensuring that the system maintains its integrity over time.

The syringe port is versatile, allowing for the delivery of both liquids and gases. This capability makes the system useful for diagnostic procedures, such as delivering contrast media or air during imaging, in addition to its primary function of feeding and medication administration. The ability to handle different types of fluids and gases increases the system's applicability in a variety of medical situations, making it a multifunctional tool in patient care.

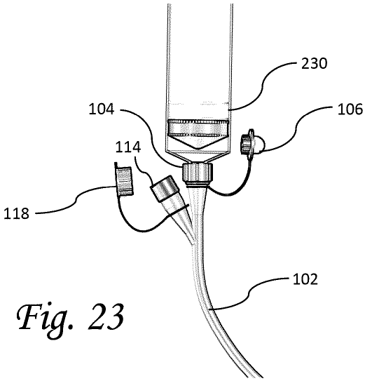

Referring to FIG. 23, an exemplary embodiment of an enteral tube system is illustrated. This embodiment corresponds to the structure shown in FIG. 9, highlighting the proximal part of an enteral tube 102. The proximal part includes a valve port 114 and a syringe/feeding port 104, with an enteral syringe 230 connected to the syringe/feeding port 104. During bolus feeding or medication administration, where a feeding pump is not utilized, the one-way valve 114 plays a critical role by eliminating the need for frequent disconnection and reconnection of the enteral syringe 230 during filling and refilling operations. This simplifies the process, improves efficiency, and minimizes handling.

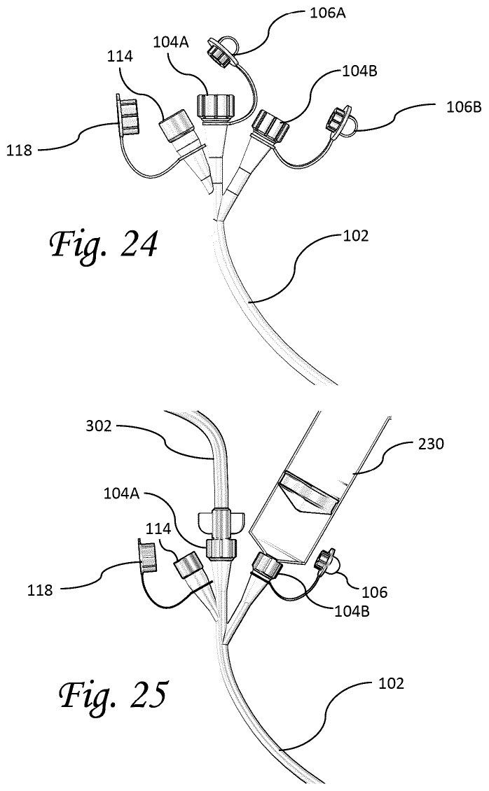

Referring to FIG. 24, another exemplary embodiment of an enteral tube 100 is shown. This embodiment features a one-way air valve 114 and two syringe/feeding ports, 104A and 104B, each equipped with corresponding covers 106A and 106B′. The syringe/feeding ports 104A and 104B are interchangeable and can be used to connect either a feeding pump tubing or an enteral syringe. This dual-port configuration enhances the system's flexibility, accommodating various clinical scenarios.

Referring to FIG. 25, the same exemplary embodiment as illustrated in FIG. 24 is depicted, with the valve port 214 in an open position. In this example, the syringe/feeding port 104A is connected to a feeding pump tubing 302, while the second syringe/feeding port 104B is connected to an enteral syringe 230. This dual-port design allows for simultaneous administration of enteral feeding via a feeding pump and medication delivery via a syringe. This configuration reduces interruptions to tube feeding, as the additional syringe/feeding port 104B provides a dedicated pathway for medication administration. Furthermore, with the integration of the one-way valve 114, the need for repeated disconnection of the enteral syringe from the syringe/feeding port is eliminated, enhancing both convenience and efficiency in clinical use.

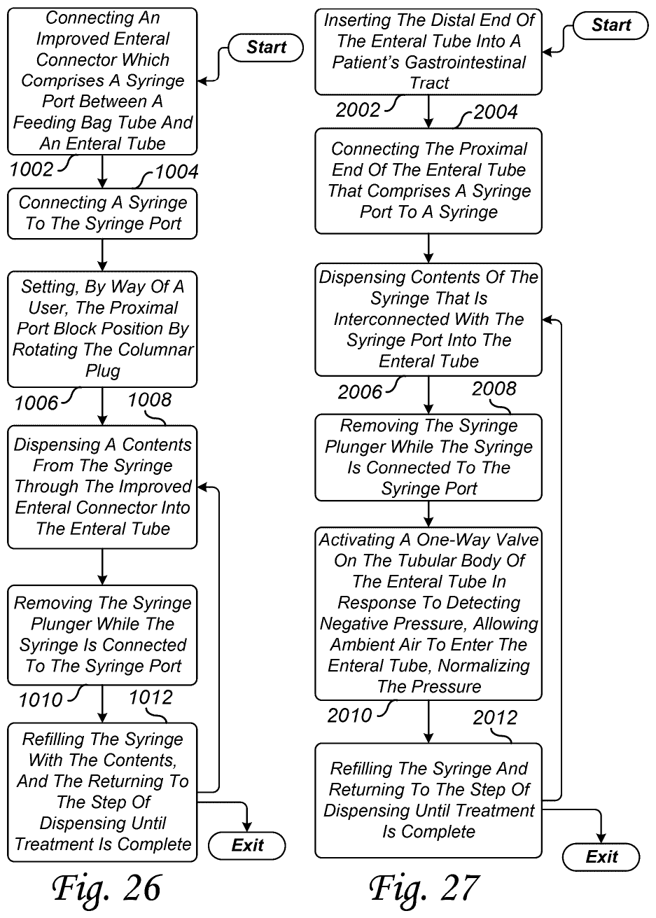

Referring to FIG. 26, there is illustrated one example of a method of using an improved enteral connector 200. The method begins in step 1002.

In step 1002, an enteral tube that is absent a one-way valve can be attached to a distal port 206 of an improved enteral connector 200. The improved enteral connector 200 comprises a cylindrical body 202. The cylindrical body 202 can comprise a valve port 204, a proximal port 210, the distal port 206, and a syringe port 208. The proximal port 208 is configured to interconnect with a feeding bag tube/suction line 302. A one-way air valve 205 interconnects within the valve port 204 and is configured to allow ambient air to ingress into the cylindrical body 202 through the one-way air valve 205 abating the buildup of negative pressure within the cylindrical valve body 202. A columnar plug 212 interconnects with the cylindrical body 202 and is rotatable to at least a proximal port block position (better illustrated in at least FIG. 3). The columnar plug 212 has more than one flow hole 215A-C that is interconnected. Each of the flow holes 215A-C is perpendicular to the outer circumference of the columnar plug 212 and extends inward interconnecting with other of the flow holes 215 proximate to the center of the interior of the columnar plug 212. Each of the flow holes 215 can be positioned on the circumference of the columnar plug 212 in a manner that when the columnar plug 212 is rotated by a user 502, to each block position, fluid communication of air or liquid is allowed to pass through the flow holes 215 between fewer than all of the following: the valve port 204, the proximal port 210, the distal port 206, and the syringe port 208. The method then moves to step 1004.

In step 1004, syringe 230 is connected to syringe port 208. The syringe 230 comprises a syringe plunger 232 that is removable from the syringe 230. The method then moves to step 1006.

In step 1006, by way of user 502, the proximal port block position (better illustrated in at least FIG. 3) is set by rotating the columnar plug 212, where at least one of the flow holes 215 A-C is aligned with each of the syringe port 208, the distal port 206, and the valve port 204 effectuating fluid communication of liquid between the syringe port 208 and the distal port 206, and fluid communication of air between the valve port 204 and the syringe port 208. The proximal port 210 is absent one of the flow holes 215 and blocked from fluid communication. The method then moves to step 1008,

In step 1008, treatment contents 504 are dispensed from the syringe 230 through the improved enteral connector 200 and into the enteral tube 100. Such treatment contents 504 can be medications, food, water flush, or other contents as may be required and/or desired in a particular embodiment or patient treatment. The method then moves to step 1010.

In step 1010, the syringe plunger 232 is removed while syringe 230 is connected to the syringe port 208. During the removal of the syringe, plunger 232 from the syringe 230 air ingresses through the one-way air valve 205 into the cylindrical body 202 abating the buildup of negative pressure that would otherwise draw gastric contents from the enteral tube 100 into the syringe 230, thus allowing the syringe 230 to remain connected to the syringe port 208 while the syringe plunger 232 is removed. The method then moves to step 1012.

In step 1012, the syringe 230 can be refilled with the treatment contents 504, and then the method returns to step 1008 the step of dispensing until treatment is complete. In this regard, the syringe 230 can be connected to the syringe port 208 once and the syringe is repeatedly filled and dispensed into the patient by removal of the plunger 232 without disconnecting the syringe 230 from the syringe port 208.

Referring to FIG. 27, there is illustrated one example of a method of delivering enteral fluids using an enteral tube system 100/200. In an exemplary embodiment, the method addresses the challenge of negative pressure buildup that occurs when the plunger 232 is removed from a syringe 230 connected to a syringe port. By integrating a one-way air valve 124 into the tubular body 102 of the enteral tube 100, the method allows ambient air to enter the tube as the syringe plunger 232 is withdrawn. This prevents the backflow of gastric contents, and the interruption of fluid delivery. The innovation enables the syringe 230 to remain securely connected to the syringe port, allowing the syringe plunger to be removed and the syringe to be refilled and reused without requiring disconnection from the port until the treatment is complete. This approach significantly reduces handling, minimizes contamination risks, and streamlines the administration process.

The steps of the method begins in step 2002 by inserting the distal end 110 of an enteral tube 100 into the patient's gastrointestinal tract. Proper placement is critical to ensure that fluids are delivered to the intended site, such as the stomach or small intestine. Placement may be confirmed using standard clinical techniques, including aspiration of gastric contents, auscultation, or imaging technologies such as X-rays. The distal end 110 of the tube includes multiple openings 112 designed to distribute fluids efficiently, ensuring optimal delivery of treatment contents.

In step 2004, the proximal end 104 of the enteral tube 100 is connected to an enteral syringe configured for fluid communication with the tube. The feeding port 104 can preferably be ENFit-compatible, ensuring secure and leak-proof connections. This step establishes a functional pathway for the introduction of fluids into the enteral tube 100.

Step 2006 involves dispensing the contents of a syringe 230 into the enteral tube 100. The syringe 230 is connected to the feeding port 104, and the plunger 232 is depressed to displace treatment contents such as enteral nutrition, medication, or water flush.

In step 2008, the syringe plunger 232 can be removed while the syringe 230 remains connected to the feeding port 104. This step often creates a negative pressure within the enteral tube 100, which in prior systems could lead to the aspiration of gastric contents or disruption of fluid delivery. In the improved system of the present invention, this challenge is mitigated by the integration of the one-way air valve 124.

Step 2010 activates the one-way air valve 124 in response to the negative pressure detected within the enteral tube 100. The one-way air valve 124, integrated along the tubular body 102 of the enteral tube 100, allows ambient air to enter the tube to normalize the pressure. The one-way air valve 124 includes a filtration element 150 to ensure that only clean air enters the system, reducing the risk of contamination. The valve activates automatically when the negative pressure reaches a predetermined threshold.

Step 2012 includes refilling the syringe 230 with additional treatment contents while maintaining its connection to the syringe port. The one-way air valve 124 ensures that the system remains stable during this step, eliminating the need for disconnection and reconnection of the syringe 230. This reduces workflow interruptions and the potential for contamination or spillage.

Finally, the method returns to step 2006, repeating the process of dispensing, removing the plunger 232, activating the one-way air valve 124, and refilling the syringe 230 as needed until the treatment is complete. This iterative approach ensures that the patient receives the prescribed volume of fluids or medication efficiently and safely.

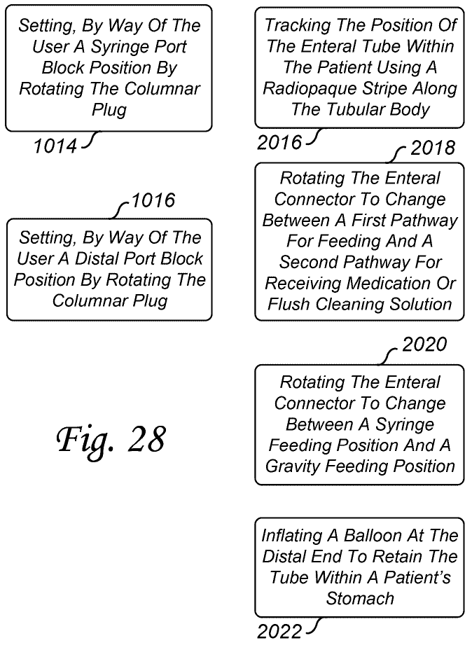

Referring to FIG. 28, there are illustrated exemplary embodiments that can be interchangeably used with the methods of the present invention.

In step 1014, by way of user 502, a syringe port block position (better illustrated in at least FIG. 2) is set by rotating the columnar plug 212, where at least one of the flow holes 215A-C is aligned with the proximal port 210, the distal port 206, and the valve port 204 effectuating fluid communication between the proximal port 210 and the distal port 206. The syringe port 208 is absent one of the flow holes 215 and blocked from fluid communication. In treatment when the suction line 302 is interconnected with the proximal port 210 the user 502 can secure the valve port cover 214 to the valve port 204 preventing air from ingressing into the cylindrical body 202 to maintain suction within the cylindrical body 202 during treatment.

In step 1016, by way of user 502, a distal port block position (better illustrated in at least FIG. 1) is set by rotating the columnar plug 212, where at least one of the flow holes 215A-C is aligned with each of the syringe port 208, the proximal port 210, and the valve port 204 effectuating fluid communication of liquid between the syringe port 208 and the proximal port 210, and fluid communication of air between the valve port 204 and the syringe port 208. The distal port 206 is absent one of the flow holes 215 and blocked from fluid communication. User 502 can secure the syringe port cover 216 to the syringe port 208. During removal of the syringe, plunger 232 from syringe 230 air ingresses through the one-way air valve 205 into the cylindrical body 202 abating the buildup of negative pressure that would otherwise draw feeding bag tube contents from the feeding bag tube 302 into the syringe 230, thus allowing the syringe 230 to remain connected to the syringe port 208 while the syringe plunger 232 is removed to refill the syringe 230 with the treatment contents 504 during treatment.

In step 2016, the method includes tracking the position of the enteral tube within the patient's body by utilizing a radiopaque stripe along the length of the tubular body. This stripe, visible through imaging techniques such as X-ray, allows healthcare providers to monitor the tube's location, ensuring proper placement and reducing the risk of misplacement during the feeding process. The inclusion of the radiopaque stripe provides a reliable way to confirm that the enteral tube is correctly positioned in the gastrointestinal tract, enhancing both the safety and effectiveness of the enteral feeding procedure.

In step 2018, the method further comprises rotating the enteral connector to switch the fluid flow between a first pathway for enteral feeding and a second pathway for receiving medication or flush cleaning solution through a syringe port. This feature allows the system to be seamlessly adjusted for different functions, such as feeding, administering medication, or flushing the tube to prevent blockages. By rotating the connector, the user can easily transition between feeding and cleaning modes without disconnecting the system, enhancing its versatility and improving overall maintenance and patient care.

In step 2020, the method further comprises rotating the enteral connector to change between a syringe feeding position and a gravity feeding position. This allows the system to be used with different types of feeding methods, depending on the patient's needs or the clinical situation. By rotating the connector, the user can easily switch between feeding modes without disrupting the system, enhancing the versatility of the enteral feeding process and ensuring that the appropriate method of delivery is used for each feeding session.

In step 2022, the method further comprises the step of inflating a balloon at the distal end of the enteral tube to retain the tube within a patient's stomach. The balloon, once inflated, helps secure the tube in the proper position, preventing it from moving or becoming dislodged during feeding. This ensures that the enteral fluids are delivered accurately to the stomach and minimizes the risk of accidental displacement, which could disrupt feeding or cause complications. The use of the inflatable balloon provides additional stability and safety for the enteral feeding process.

The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

While the preferred embodiment of the invention has been described, it will be understood that those skilled in the art, both now and in the future, may make various improvements and enhancements which fall within the scope of the claims which follow. These claims should be construed to maintain the proper protection for the invention first described.

What is claimed is:

1. An enteral tube system, comprising:
a tubular body having a proximal end and a distal end, the proximal end configured for fluid communication with an external feeding source;
a valve port integrated along the tubular body, a one-way air valve configured and fitted into the valve port to allow ambient air to enter the tubular body when negative pressure is detected within the tube, the valve preventing the exit of gastrointestinal contents;
a removable valve cover operably associated with the valve port, the valve cover configured to seal the valve port, preventing operation of the one-way air valve when in a closed position; and
an enteral connector in fluid communication with the tubular body, configurable to block or unblock fluid pathways.

2. The enteral tube system of claim 1, wherein the enteral connector comprises a syringe port configured to facilitate the administration of fluids or medication, and wherein the one-way air valve is further configured to equalize negative pressure within the tubular body when a syringe is connected to the syringe port and the syringe plunger is being removed, thereby preventing the formation of a vacuum condition in the tubular body.

3. The enteral tube system of claim 1, wherein the enteral connector comprises a rotatable valve mechanism operable to selectively control fluid flow between a feeding bag, the syringe port, and the proximal end of the enteral tube, enabling independent or simultaneous fluid delivery paths.

4. The enteral tube system of claim 1, wherein the tubular body includes a valve port integrated along its length, the valve port configured to receive the one-way air valve, and further comprising a removable valve cover operably associated with the valve port, the valve cover configured to seal the valve port and prevent operation of the one-way air valve while protecting the valve port and the one-way air valve from external contaminants when in a closed position.

5. The enteral tube system of claim 1, further comprising a plurality of openings located at the distal end of the tubular body for the delivery of enteral fluids into a patient.

6. The enteral tube system of claim 1, wherein the proximal end of the tubular body includes an ENFit-compatible connector.

7. The enteral tube system of claim 1, wherein the tubular body is constructed from a biocompatible material selected from the group consisting of silicone, polyurethane, and latex.

8. The enteral tube system of claim 1, wherein the valve port is integrated along the tubular body and positioned at an angle relative to the tubular body, the angle optimized to facilitate air flow into the tubular body during patient movement, ensuring consistent operation of the one-way air valve.

9. The enteral tube system of claim 1, wherein the tubular body is constructed from a biocompatible material selected from the group consisting of silicone, polyurethane, and latex, the material configured to provide flexibility, durability, and resistance to gastrointestinal fluids during extended use.

10. The enteral tube system of claim 1, further comprising a radiopaque stripe along the tubular body for tracking during insertion.

11. A method of delivering enteral fluids using an enteral tube system, the method comprising:
inserting a distal end of an enteral tube into a patient's gastrointestinal tract;
connecting a proximal end of the enteral tube to an enteral feeding system, wherein the enteral feeding system comprises a syringe port configured for fluid communication with the enteral tube;
dispensing contents of a syringe into the enteral tube, the syringe being interconnected with the syringe port;
removing a syringe plunger while the syringe remains connected to the syringe port, wherein the removal generates a negative pressure within the enteral tube;
activating the one-way air valve, the one-way valve is fitted into the valve port, the valve port is integrated along the tubular body of the enteral tube, the one-way air valve allowing ambient air to enter the tubular body when negative pressure is detected;
refilling the syringe with treatment contents while maintaining its connection to the syringe port; and
returning to the step of dispensing until treatment is complete.

12. The method of claim 11, wherein the one-way air valve comprises a filtration element configured to prevent contaminants from entering the enteral tube while allowing ambient air to normalize the pressure.

13. The method of claim 11, further comprising the step of securing a removable valve cover over the one-way air valve after completing the treatment, the valve cover configured to seal the valve port and protect the one-way air valve from external contaminants.

14. The method of claim 11, wherein the step of dispensing contents of the syringe further comprises:
adjusting a rotatable connector positioned at the proximal end of the enteral tube to selectively open a fluid pathway for dispensing, and
closing the fluid pathway for other operations without disconnecting the syringe from the syringe port.

15. The method of claim 11, further comprising monitoring the pressure within the enteral tube, wherein the activation of the one-way air valve is triggered automatically when the negative pressure reaches a threshold of approximately −20 mmHg.

16. An enteral tube system comprising:
a tubular body having a proximal end and a distal end, the distal end configured for insertion into a patient's gastrointestinal tract;
a one-way air valve integrated into the tubular body, the one-way air valve configured to allow ambient air to enter the tubular body when negative pressure is detected and to prevent backflow of gastric contents;
an enteral connector integrated with the proximal end of the tubular body, the enteral connector comprising:
a syringe port integrated into the enteral connector and configured to receive a syringe for dispensing fluids into the tubular body; and
a rotatable valve mechanism operable to selectively control fluid pathways between the syringe port, a feeding bag connection port, and the tubular body.

17. The enteral tube system of claim 16, wherein the one-way air valve is configured to activate at a negative pressure threshold between −15 mmHg and −25 mmHg.

18. The enteral tube system of claim 16, wherein the tubular body includes a valve port integrated along its length, the valve port sized and configured to receive the one-way air valve, and further comprising a removable valve cover operably associated with the valve port, the valve cover configured to seal the valve port, prevent operation of the one-way air valve, and protect the valve port and the one-way air valve from external contaminants when in a closed position.

19. The enteral tube system of claim 16, wherein the enteral connector is configured to permit simultaneous independent fluid flow from the feeding bag connection port and the syringe port into the tubular body, allowing dual-source feeding capabilities while maintaining separate control over each fluid pathway.

20. The enteral tube system of claim 16, wherein the proximal end of the tubular body includes an ENFit-compatible connector.
